(19) United States
(12) Patent Application Publication
(10) Pub. No.: US 2007/0056418 A1
(43) Pub. Date: Mar. 15, 2007

(54) Power tool having cabinet

(76) Inventors: Yu-Chuan Lung, Taichung Hsien (TW); Ya-Lin Wu, Taichung Hsien (TW); Cheng-Hung Chiu, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 11/519,777

(22) Filed: Sep. 13, 2006

(30) Foreign Application Priority Data
Sep. 13, 2005 (TW) 94215755

(51) Int. Cl. B27B 27/04

(52) U.S. Cl. 83/477.2

(57) ABSTRACT

A power tool provided by the present invention includes a tool body for holding and processing a workpiece, and a cabinet standing on a floor. The cabinet has a platform connected to the tool body, a bottom plate, a peripheral wall defining an accommodation space and having a top part surrounding a periphery of the platform, and a bottom part surrounding a periphery of the bottom plate, and a door provided at one side of the peripheral wall. The area surrounded by the periphery of the bottom plate is greater than the area surrounded by the periphery of the platform.

### BACKGROUND OF THE INVENTION

1. Field of the Invention

The present invention relates to a power tool, and more particularly to a power tool having a cabinet incorporated therewith.

2. Description of the Related Art

As shown in FIG. 1, a conventional table saw 80 generally comprises a worktable 81, a base 82, a saw blade holder (not shown), a saw blade 83, and a stand 84. The worktable 81 is adapted to hold a workpiece 85 and has a cutting slot 812 through which the saw blade 83 partially extends for cutting the workpiece 85. The base 82 is fixedly connected to the bottom side of the worktable 81 for supporting the worktable 81. The saw blade holder is mounted inside the base 82 to hold the saw blade 83 for driving the saw blade 83 to rotate. The stand 84 is connected to the bottom side of the base 82 for supporting the base 82 up to a predetermined height above the floor so that the operator can operate the worktable saw 80 conveniently.

The stand 84 is composed of twelve rods, including four stand rods 841, four top rods 842 and four transverse connecting rods 843. The stand rods 841 and the top rods 842 each have an L-shaped cross-section. Each of the top rods 842 are fastened at two ends thereof to the top ends of two stand legs 841 so that the top rods 842 form a rectangular frame at top part of the stand 84 for connection with the base 82. Each of the transverse connecting rods 843 are fixedly connected at two ends thereof to the lower portions of two stand rods 841 to reinforce the structural strength of the stand 84. Further, threaded bolts 844 and nuts 845 are used to fasten the stand rods 841, the top rods 842 and the connecting rods 843 of the stand 84 together. Therefore, mounting holes must be drilled on the stand rods 841, top rods 842 and connecting rods 843 of the stand 84 precisely in advance to be inserted by the threaded bolts 844. According to this design, the twelve rods of the stand 84 define totally sixteen junctions that are respectively fixed by inserting the threaded bolts 844 and then screwing the nuts 845 onto the threaded bolts 844. Therefore, the assembly procedure of the stand 84 becomes complicated, and requires much time. Further, the stand 84 does not provide a storage space for keeping some tools or articles, thereby resulting in inconvenience to the user.

### SUMMARY OF THE INVENTION

It is the primary objective of the present invention to provide a power tool having a cabinet, which can eliminate the problem of the aforesaid prior art.

To achieve this objective of the present invention, the power tool provided by the present invention comprises a tool body for holding and processing a workpiece, and a cabinet standing on a floor. The cabinet has a platform connected to the tool body, a bottom plate, a peripheral wall defining an accommodation space and having a top part surrounding a periphery of the platform, and a bottom part surrounding a periphery of the bottom plate, and a door provided at one side of the peripheral wall. The area surrounded by the periphery of the bottom plate is greater than the area surrounded by the periphery of the platform.

Further, the platform and the peripheral wall can be formed as a unity so as to solve the time-consuming and inconvenient problems in assembling the stand of the aforesaid table saw. The door controls access to the accommodation space defined within the cabinet, thereby enabling the user to put tools and/or articles into the accommodation space conveniently for storage. After removing the bottom plate from the peripheral wall, the tool body of the power tool can be directly received, without disassembly in advance, inside the cabinet such that the power tool can be packed in a smaller carton for saving space and delivered conveniently.

### BRIEF DESCRIPTION OF THE DRAWING

FIG. 1 is a perspective view of a table saw according to the prior art.

FIG. 2 is a perspective view of a power tool according to a preferred embodiment of the present invention.

FIG. 3 is an exploded view of the cabinet shown in FIG. 2.

FIG. 4 is a perspective view similar to FIG. 2, but showing that a rip fence and a miter gauge are removed from the worktable and mounted to the tool holder.

FIG. 5 is a schematic drawing showing the structure of the inner surface of the door according to the preferred embodiment of the present invention.

FIG. 6 is a sectional view of a height-adjusting device according to the preferred embodiment of the present invention.

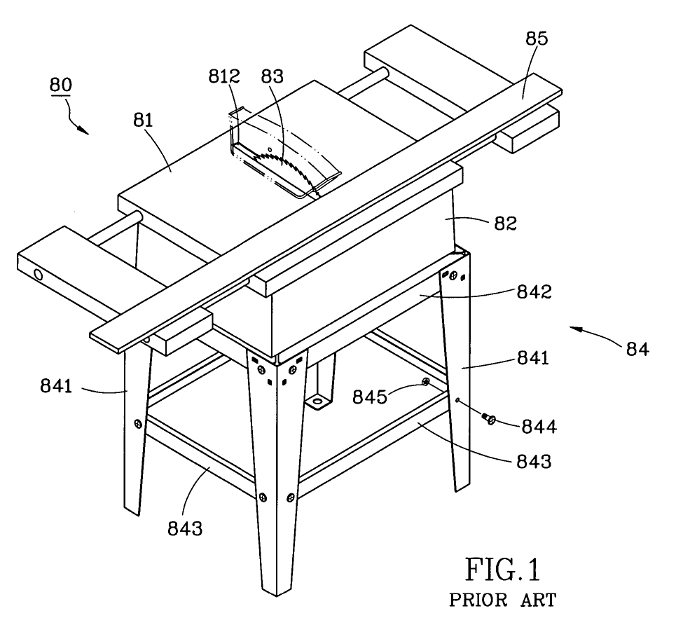

### DETAILED DESCRIPTION OF THE INVENTION

The present invention provides a cabinet of a power tool adapted to be cooperatively used with a tool body of the power tool, such as a table saw, a planer, a router, etc. The structure and function of the cabinet and the tool body are described hereunder. In the following embodiment, the present invention selects the table saw as the representative example of the tool body for the purpose of illustration.

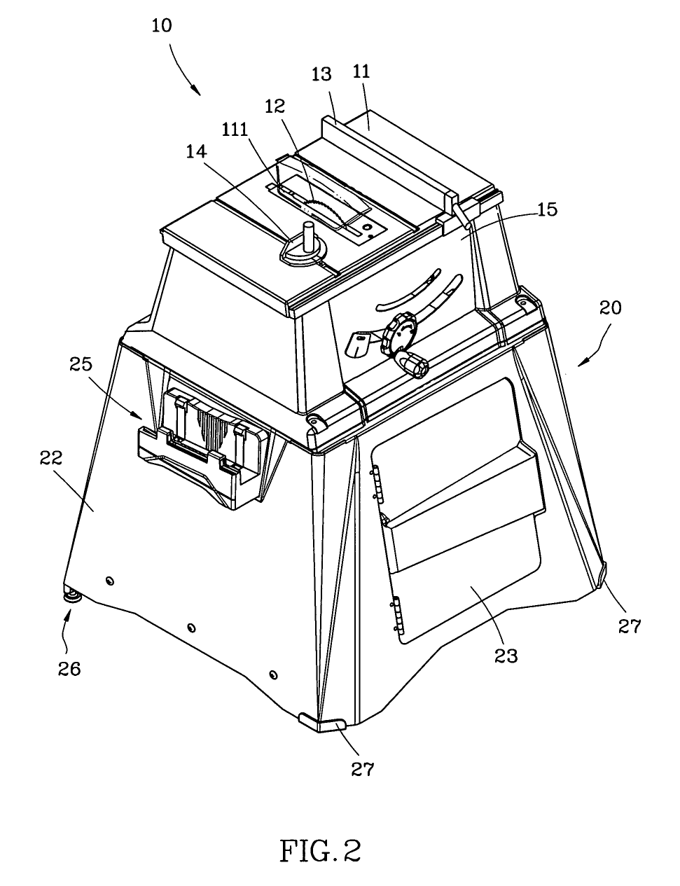

As shown in FIG. 2, the power tool provided by a preferred embodiment of the present invention comprises a tool body 10 having a worktable 11, a saw blade 12, a rip fence 13, a miter gauge 14, a base 15 and a saw blade holder (not shown), and a cabinet 20. The worktable 11 is a flat plate member, and has an upper surface holding thereon a workpiece (not shown), defining an area, and a cutting slot 111 through which the saw blade 12 extends for cutting the workpiece held on the worktable 11. The rip fence 13 is detachably movably supported on the worktable 11 in parallel to the saw blade 12 for guiding one side of the workpiece to parallel the saw blade 12. The miter gauge 14 is detachably movably mounted on the worktable 11 and provided with a plane perpendicular to the worktable 11 for guiding the workpiece to be cut by the saw blade 12 with a desired cutting angle relative to the saw blade 12. The included angle between the plane and the saw blade 12 is adjustable. The base 15 is provided at the bottom side of the worktable 11 and fixedly connected to the worktable 11 for supporting the worktable 11. The saw blade holder (not shown) is pivotally mounted inside the base 15 for driving the saw blade 12 to rotate. The cabinet 20 is provided at the bottom side of the base 15 and connected to the base 15 for supporting the base 15 above the floor at a predetermined height.

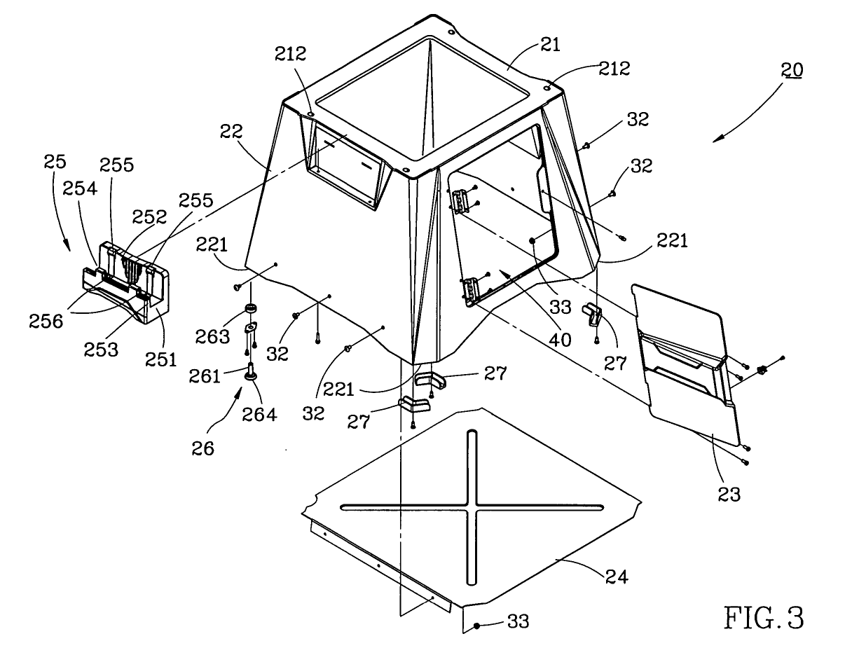

Referring to FIG. 3, the cabinet 20 comprises a platform 21, a peripheral wall 22, a door 23, a bottom plate 24, a tool holder 25, a height-adjusting device 26, and three pad members 27. The platform 21 can be a frame or a plate. According to this embodiment, the platform 21 is embodied as a rectangular frame for illustrative purpose. The platform 21 is connected to the base 15 by the threaded bolts and the nuts screwed into the threaded bolts. The threaded bolts are inserted respectively through the mounting holes in the bottom wall of the base 15 and the mounting holes 212 in the platform 21 and then fastened up respectively by the nuts to firmly clamp the platform 21 and the base 15. The positions and numbers of the mounting holes in the bottom wall of the base 15 are corresponding to the positions and numbers of the mounting holes 212 in the platform 21. In this embodiment, the numbers of mounting holes 212 are four, for example. The platform 21 and the periphery wall 22 are formed as a unity. The peripheral wall 22 has a top part surrounding a periphery of the platform 21, and a bottom part surrounding a periphery of the bottom plate 24. The periphery of the bottom plate 24 is fastened to the bottom part of the periphery wall 22 by the threaded bolts 32 and the nuts 33 screwed into the threaded bolts 32. Thus, the platform 21, the peripheral wall 22 and the bottom plate 24 define an accommodation chamber 40 therein. The peripheral wall 22 forms four legs 221 at four corners of the bottom part thereof below the bottom plate 24. The height-adjusting device 26 and the three pad members 27 are respectively mounted to the bottom ends of the legs 221 and kept in contact with the floor.

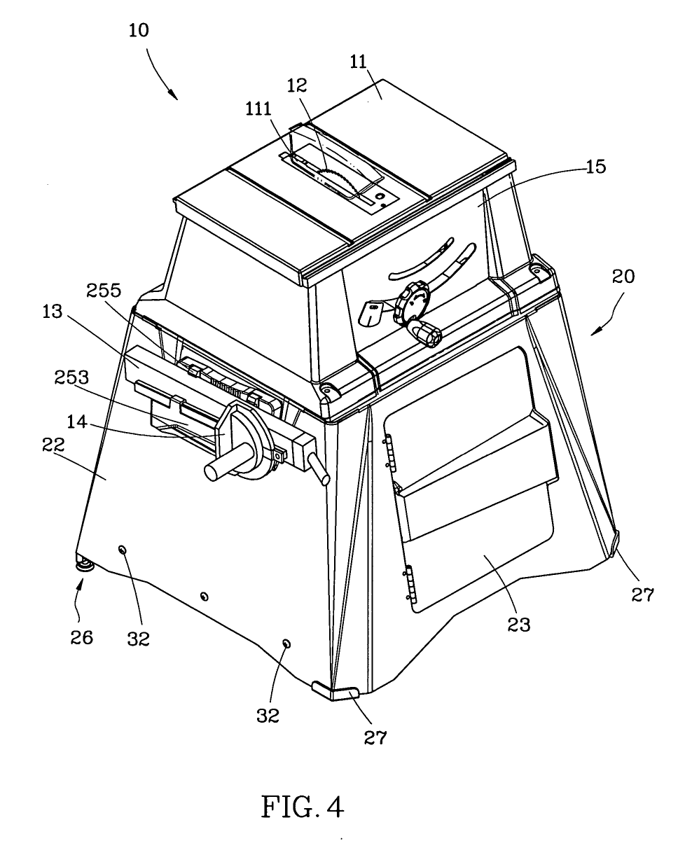

Referring to FIG. 3 and FIG. 4, the tool holder 25 is provided at one side of the peripheral wall 22. The door 23 is provided at another side of the peripheral wall 22 adjacent to the side carrying the tool holder 25. The tool holder 25 is a substantially U-shaped holder and has a bottom wall 251, a first sidewall 252 and a second sidewall 253. The first sidewall 252 and the second sidewall 253 respectively upwardly extend from opposite two sides of the bottom wall 251. The sidewalls 252 and 253 define with the bottom wall 251 a mounting groove 254. Further, two retaining hooks 255 are provided at the first sidewall 252. After the rip fence 13 is removed from the worktable 11 and inserted into the mounting groove 254, a rim of the rip fence 13 is hooked by the retaining hooks 255 for keeping the rip fence 13 firmly in the mounting groove 254. The top part of the second sidewall 253 has two through holes 256 aligned in a line. After removal of the miter gauge 14 from the worktable 11, the miter gauge 14 can be pierced into the through holes 256.

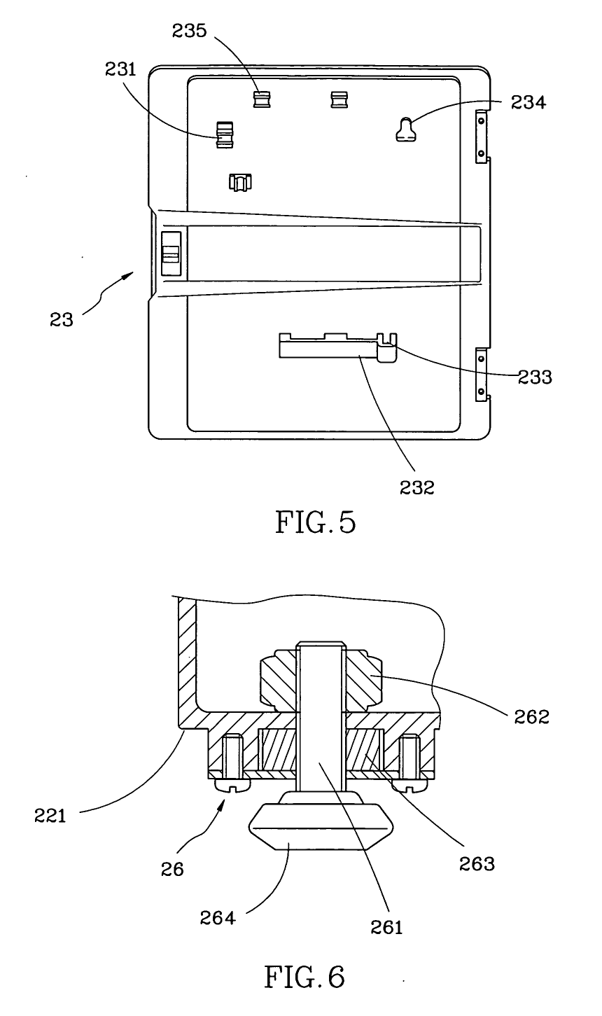

Referring to FIGS. 3 and 5, the door 23 is hinged to the side of the peripheral wall 22 close to the operator. As shown in FIG. 5, the inner surface of the door 23 is provided with a plurality of clamping members 231, and a mounting member 232. When the door 23 is opened, the operator can put tools and/or articles into the accommodation chamber 40. When the door 23 is closed, the door 23 isolates the accommodation chamber 40 from the space outside the power tool. The clamping members 231 are mounted on the inner surface of the door 23 facing the accommodation chamber 40. Each of the clamping members 231 has opposite two clamping pieces 235 for clamping things. Further, two clamping members 231 aligned in a line can clamp an elongated member, for example. Two clamping members 231 that are respectively arranged at two sections of an L-shaped path can clamp an L-shaped member, for example, an L-shaped hex wrench. The mounting member 232 protrudes outwards from the inner surface of the door 23 and has a plurality of receiving grooves 233 for keeping tool accessories or other small items. Further, a hanging hook 234 is provided at the inner surface of the door 23 for hanging things.

Referring to FIG. 6 and FIG. 3, the height-adjusting device 26 has an adjustable threaded bolt 261, a first nut 262, a second nut 263, and a pad 264. The pad 264 is fixedly mounted on one end of the adjustable threaded bolt 261 and disposed in contact with the floor. The first nut 262 is provided on the top side of the bottom wall of one of the legs 221 formed by the peripheral wall 22. The second nut 263 is fixedly provided on the bottom side of the bottom wall of the leg 221. The adjustable threaded bolt 261 is screwed through the second nut 263 and then the first nut 262. When the operator wants to adjust the height of the height-adjusting device 26, the operator can firstly loosen the first nut 262, and then rotate the adjustable threaded bolt 261 upwards or downwards to a desired height, and then fasten up the first nut 262 again to complete the height adjustment.

According to the present invention, the platform 21 is formed with the peripheral wall 22 as a unity. Therefore, the assembling procedure of the cabinet 20 is simple. Further, the door 23 is hinged to the side of the peripheral wall 22 to control access to the accommodation chamber 40. Thereby, the operator can store tools and/or articles in the accommodation chamber 40.

Referring to FIG. 4, the area of the bottom plate 24 is greater than the area surrounded by the outside periphery of the platform 21. Therefore, the cabinet 20 is shaped like a prism having a great bottom side and a small top side. The area surrounded by the outside periphery of the platform 21 is about equal or slightly greater than the area surrounded by the outside periphery of the bottom wall of the base 15. The vertical height of the peripheral wall 22 is greater than the combined height defined by the worktable 11 and the base 15. Further, the crosssection area of the peripheral wall 22 that is parallel to and spaced from the floor to a distance equal to the combined height defined by the worktable 11 and the base 15 is greater than the area of the upper surface of the worktable 11. Therefore, after disconnection of the bottom plate 24 from the peripheral wall 22, the tool body 10 can be directly received, without disassembly in advance, inside the cabinet 20 in standing such that the power tool can be packed in a smaller carton for saving space and delivered conveniently.

Further, the cabinet 20 can be alternatively designed in another manner that the crosssection area of the peripheral wall 22 that is parallel to and spaced from the platform 21 to a distance equal to the combined height defined by the worktable 11 and the base 15 is greater than the area of the upper surface of the worktable 11. Thus, the tool body 10 can be received inside the cabinet 20 turned upside down to save the stored space.

Although a particular embodiment of the invention has been described in detail for purpose of illustration, various modifications and enhancements may be made without departing from the spirit and scope of the invention. Accordingly, the invention is not to be limited except as by the appended claims.

What is claimed is:

1. A power tool comprising:
a tool body for holding and processing a workpiece; and
a cabinet standing on a floor and having a platform connected to the tool body, a peripheral wall defining an accommodation space and having a top part surrounding the periphery of the platform, wherein an area surrounded by the periphery of the platform is less than a crosssection area surrounded by a bottom part of the peripheral wall.

2. The power tool as claimed in claim 1, wherein the tool body comprises:
a worktable having an upper surface holding the workpiece thereon and defining an area;
a base connected to the worktable for supporting the worktable;
a saw blade extending through the worktable; and
a saw blade holder located inside the base and driving the saw blade to rotate.

3. The power tool as claimed in claim 2, wherein the worktable and the base, which are connected with each other, define a combined height, and a crosssection area of the peripheral wall parallel to the platform and spaced from the platform to a distance equal to the combined height is greater than the area of the upper surface of the worktable.

4. The power tool as claimed in claim 2, wherein the worktable and the base, which are connected with each other, define a combined height; and a crosssection area of the peripheral wall parallel to the floor and spaced from the floor to a distance equal to the combined height is greater than the area of the upper surface of the worktable.

5. The power tool as claimed in claim 2, wherein the worktable has a rip fence detachably movably mounted thereon and parallel to the saw blade, and the peripheral wall has a tool holder mounted thereon and having a mounting groove for receiving the rip fence.

6. The power tool as claimed in claim 5, wherein the tool holder has a retaining hook connected to a side wall of the mounting groove for engaging with the rip fence after the rip fence is received in the mounting groove.

7. The power tool as claimed in claim 2, wherein the worktable has a miter gauge detachably movably mounted thereon for guiding a desired cutting angle of the workpiece relative to the saw blade, and the peripheral wall has a tool holder mounted thereon and having a through hole for insertion of the miter gauge.

8. A power tool comprising:
a tool body for holding and processing a workpiece; and
a cabinet standing on a floor and having a platform connected to the tool body, a bottom plate, wherein the area surrounded by a periphery of the bottom plate is greater than the area surrounded by a periphery of the platform, a peripheral wall defining an accommodation space and having a top part surrounding the periphery of the platform, and a bottom part surrounding the periphery of the bottom plate, and a door provided at one side of the peripheral wall.

9. The power tool as claimed in claim 8, wherein the peripheral wall has four legs located below the bottom plate, and a height-adjusting device mounted to one of the legs for adjusting the height from the leg to the floor.

10. The power tool as claimed in claim 8, wherein the door is provided at an inner surface thereof that faces the accommodation space with a clamping member.

11. The power tool as claimed in claim 8, wherein the door is provided at an inner surface thereof that faces the accommodation space with a hanging hook.

12. The power tool as claimed in claim 8, wherein the door is provided at an inner surface thereof that faces the accommodation space with a mounting member having a receiving groove.

13. The power tool as claimed in claim 8, wherein the bottom plate is fastened to the peripheral wall by threaded bolts and nuts.

14. A power tool comprising:
a tool body for holding and processing a workpiece; and
a cabinet standing on a floor and having a platform connected to the tool body, a peripheral wall defining an accommodation space capable of receiving the tool body and having a top part surrounding the periphery of the platform, wherein an area surrounded by the periphery of the platform is less than a crosssection area surrounded by a bottom part of the peripheral wall.

15. The power tool as claimed in claim 14, wherein a cabinet has a bottom plate surrounded by the bottom part of the peripheral wall, and a door provided at one side of the peripheral wall.

16. The power tool as claimed in claim 15, wherein the peripheral wall has four legs located below the bottom plate, and a height-adjusting device mounted to one of the legs for adjusting the height from the leg to the floor.

17. The power tool as claimed in claim 15, wherein the door is provided at an inner surface thereof that faces the accommodation space with a clamping member.

18. The power tool as claimed in claim 15, wherein the door is provided at an inner surface thereof that faces the accommodation space with a hanging hook.

19. The power tool as claimed in claim 15, wherein the door is provided at an inner surface thereof that faces the accommodation space with a mounting member having a receiving groove.

20. The power tool as claimed in claim 15, wherein the bottom plate is fastened to the peripheral wall by threaded bolts and nuts.
